(19) United States
(12) Patent Application Publication
(10) Pub. No.: US 2021/0007008 A1
(43) Pub. Date: Jan. 7, 2021

(54) METHOD AND APPARATUS FOR DATA SEGMENTATION AND REASSEMBLY OVER MULTIPLE WIRELESS LINKS

(71) Applicant: William Anthony GAGE, Stittsville (CA)

(72) Inventor: William Anthony GAGE, Stittsville (CA)

(73) Assignee: HUAWEI TECHNOLOGIES CO., LTD., SHENZHEN (CN)

(21) Appl. No.: 16/906,454

(22) Filed: Jun. 19, 2020

Related U.S. Application Data
(60) Provisional application No. 62/871,013, filed on Jul. 5, 2019.

(51) Int. Cl. H04W 28/06; H04W 80/02; H04L 1/18

(52) U.S. Cl. CPC H04W 28/065; H04W 84/18; H04L 1/1896; H04W 80/02

(57) ABSTRACT

Method apparatus and system, for reconstructing a radio link control (RLC) service data unit (SDU) in a wireless communication network are provided. An RLC SDU reassembly component receives segments of an RLC SDU from different, independently operating RLC reception components and reconstructs the RLC SDU from these segments. The RLC reception components operate independently using different communication links and forward each segment upon successful reception, rather than waiting for an entire SDU to be successfully received. Each reception component may use ARQ for reliable reception of segments. Segments include an indication of their position in the SDU to facilitate the reconstruction.

### CROSS-REFERENCE TO RELATED APPLICATION

This application claims priority to U.S. Provisional Patent Application No. 62/871,013 entitled “Method and Apparatus for Data Segmentation and Reassembly over Multiple Wireless Links” filed Jul. 5, 2019, the entire contents of which are incorporated herein by reference.

### FIELD OF THE INVENTION

The present invention pertains to the field of packet-based data communications in a wireless network and in particular to a method and apparatus for reducing latencies in communications within the wireless network.

### BACKGROUND

A radio access network (RAN) node in a Third Generation Partnership Project (3GPP) Fifth Generation (5G) system may be connected to a core network (CN) control plane entity through an interface known as N2 (or NG-C) and to a CN user plane entity through an interface known as N3 (or NG-U). The CN control plane entity is also connected to user equipment (UE) through an interface known as N1. In a 3GPP Long Term Evolution (LTE) system, similar interfaces exist.

A RAN node is also connected to a wireless device (WD) such as user equipment (UE) via an orthogonal frequency division multiplexed (OFDM) radio link interface, known as Uu, that comprises several entities associated with the radio link protocol stack: a physical layer (PHY) entity, a medium access control (MAC) entity, a radio link control (RLC) entity, a packet data convergence protocol (PDCP) entity, a service data adaptation protocol (SDAP) entity, and a radio resource control (RRC) entity.

The foregoing background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a method and apparatus for data segmentation and reassembly over multiple radio links in a wireless communication system. In embodiments herein, an RLC receiver is decomposed into two components: an RLC reassembly component, and two or more RLC reception components wherein each RLC reception component is associated with one of the radio links.

In accordance with a broad aspect, there is provided a method, for example for reconstructing a radio link control (RLC) service data unit (SDU) in a wireless network. The method includes receiving, by a RLC reassembly component, a first segment of the RLC SDU. The first segment may be forwarded by a first RLC reception component associated with a first radio link. The first segment includes one or more octets of the RLC SDU. For clarity, it is noted that the RLC SDU may have been segmented (e.g. divided) for transmission over multiple radio links of the wireless network, the multiple radio links in such embodiments include the first radio link. The method includes receiving, by the RLC reassembly component, a second segment of the RLC SDU. The second segment may be forwarded by a second RLC reception component associated with a second radio link (of multiple radio links) which is different from the first radio link. The second segment includes one or more of the octets of the RLC SDU. The octets of the RLC SDU included in the first and the octets of the RLC SDU included in the second segment are typically different, but possibly overlapping. The method includes outputting, by the RLC reassembly component, the reconstructed RLC SDU. The method may further include reconstructing the RLC SDU. The reconstructed RLC SDU is assembled based on at least the first segment and the second segment. The reconstructed RLC SDU is reconstructed so that it includes all octets of the RLC SDU. Providing the reconstructed RLC SDU may include generating the RLC SDU, outputting the RLC SDU to another internal part of a device, or transmitting the RLC SDU to an external device.

In accordance with the preceding broad aspect, the method further includes, when the reconstructed RLC SDU comprises all of the octets of the RLC SDU, forwarding the reconstructed RLC SDU to another entity in a wireless device or a radio access primary node in the wireless network configured to receive and handle the RLC SDU as a unit of data.

In accordance with any of the preceding aspects, the method includes receiving, by an RLC reception component associated with the first radio link (e.g. the first RLC reception component), the first segment of the RLC SDU; forwarding, by the RLC reception component, the first segment of the RLC SDU to the RLC reassembly component; and discarding, by the RLC reception component, the first segment of the RLC SDU.

In accordance with any of the preceding aspects, the first segment is received by the RLC reception component in response to an automatic repeat request (ARQ) transmitted by the RLC reception component.

In accordance with any of the preceding aspects, the method further includes sending, by the RLC reassembly component, a stop indication to at least one RLC reception component when the reconstructed RLC SDU comprises all of the octets of the RLC SDU, the stop indication associated with the RLC SDU.

In accordance with any of the preceding aspects, the method further includes starting, by the RLC reassembly component, a reassembly timer when the first segment of the RLC SDU is received and stopping the reassembly timer when the RLC reassembly component determines that the reconstructed RLC SDU comprises all of the octets of the RLC SDU.

In accordance with any of the preceding aspects, each of the first segment and the second segment comprise an end segment indication, and the method further includes determining when the reconstructed RLC SDU comprises all of the octets of the RLC SDU based on the end segment indication.

In accordance with any of the preceding aspects, the method further includes starting, by the RLC reassembly component, a reassembly timer when the first segment of the RLC SDU is received and discarding further received segments of the RLC SDU when the reassembly timer expires.

In accordance with any of the preceding aspects, a number of octets in the second segment of the RLC SDU is the same or different from a number of octets in the first segment of the RLC SDU.

In accordance with any of the preceding aspects, each of the first segment and the second segment comprise an indication of which octets of the RLC SDU are contained therein, and the method further includes reconstructing the RLC SDU based on the indication.

In accordance with a broad aspect, there is provided a radio access network (RAN) primary node (RPN) in a wireless network. The RPN may comprise a network interface. The RPN comprises a processor; and a non-transitory memory storing instructions that when executed by the processor cause the RPN to perform the following operations. The RPN receives a first segment of a radio link control (RLC) service data unit (SDU). The first segment may have been forwarded by a first RLC reception component associated with a first radio link. The first segment includes one or more octets of the RLC SDU. The RLC SDU may have been segmented for transmission across multiple radio links of the wireless network, the multiple radio links including the first radio link. The RPN also receives a second segment of the RLC SDU. The second segment includes one or more of the octets of the RLC SDU. The octets of the second segment may have been forwarded by a second RLC reception component associated with a second radio link of the multiple radio links. A number of octets of the RLC SDU in the second segment may be the same or different from a number of octets of the RLC SDU in the first segment. The RPN also outputs a reconstructed RLC SDU, the reconstructed RLC SDU being assembled based on at least the first segment and the second segment and including all octets of the RLC SDU.

In accordance with the preceding aspect, the RPN comprises a RAN node centralised unit (CU).

In accordance with any of the preceding aspects, the RPN comprises a master cell group (MCG) RAN node.

In accordance with any of the preceding aspects, the RPN is further configured, when the reconstructed RLC SDU comprises all of the octets of the RLC SDU, to forward the reconstructed RLC SDU to another entity in the RPN, or in the wireless network. The other entity may be configured to receive and handle the RLC SDU as a unit of data.

In accordance with any of the preceding aspects, each of the first segment and the second segment comprise an end segment indication, and the RPN is further configured to determine when the reconstructed RLC SDU comprises all of the octets of the RLC SDU based on the end segment indication.

In accordance with any of the preceding aspects, the RPN is further configured to transmit a stop indication associated with the RLC SDU to one or more RLC reception components, when the reconstructed RLC SDU comprises all of the octets of the RLC SDU.

In accordance with any of the preceding aspects, the RPN is further configured to start a reassembly timer when the first segment of the RLC SDU is received and to stop the reassembly timer when the RPN determines that the reconstructed RLC SDU comprises all of the octets of the RLC SDU.

In accordance with any of the preceding aspects, the RPN is further configured to start a reassembly timer when the first segment of the RLC SDU is received and to discard further segments of the RLC SDU (received from RLC reception components) when the RPN determines that the reassembly timer has expired.

In accordance with any of the preceding aspects, each of the first segment and the second segment comprise an indication of which octets of the RLC SDU are contained therein, the RPN further configured to reconstruct the RLC SDU based on the indication.

In accordance with a broad aspect, there is provided a system that comprises a first radio link control (RLC) reception component. The first RLC reception component is configured to wirelessly receive, over a first radio link, a first set of segments of a radio link control (RLC) service data unit (SDU). Each segment of the first set of segments includes one or more octets of the RLC SDU. The RLC SDU may be segmented for transmission across multiple radio links of a wireless network, and in such embodiments the multiple radio links include the first radio link. The first RLC reception component is configured to forward each segment of the first set of segments of the RLC SDU to an RLC reassembly component. The system further comprises a second RLC reception component. The second RLC reception component is configured to wirelessly receive a second set of segments of the RLC SDU. Each segment of the second set of segments may include one or more octets of the RLC SDU received over a second radio link of the multiple radio links. In such embodiments the second radio link is different from the first radio link. The second RLC reception component is further configured to forward each segment of the second set of segments of the RLC SDU to the RLC reassembly component. The system further comprises the RLC reassembly component. The RLC reassembly component is configured to receive the first set of segments of the RLC SDU; receive the second set of segments of the RLC SDU; and output a reconstructed RLC SDU. The reconstructed RLC SDU is assembled based on at least the first set of segments and the second set of segments, and may include all octets of the RLC SDU.

In accordance with the preceding aspect, the RLC reassembly component is located in a primary node of a radio access network (RAN), and each of the RLC reception components is located in a different respective secondary node of the RAN.

In accordance with any of the preceding aspects, the RLC reception component is configured to reliably receive the set of segments using an automatic repeat request (ARQ) protocol.

In accordance with any of the preceding aspects, the RLC reassembly component is further configured to send a stop indication associated with the RLC SDU to one or both of the first RLC reception component and the second RLC reception component when the reconstructed RLC SDU at the RLC reassembly component comprises all octets of the RLC SDU. In such embodiments, the first RLC reception component and the second RLC reception component are configured to stop reception operations for the RLC SDU upon receiving the stop indication.

In accordance with any of the preceding aspects, the first set of segments of the RLC SDU is associated with a first copy of the RLC SDU and the second set of segments of the RLC SDU is associated with a second copy of the RLC SDU.

In accordance with any of the preceding aspects, transmission of the first set of segments of the RLC SDU over the first radio link is performed independently of transmission of the second set of segments of the RLC SDU over the second radio link.

In accordance with any of the preceding aspects, a first segment from the first set of segments and a second segment from the second set of segments both include a same first one or more octets of the RLC SDU, and the RLC reassembly component is configured to reconstruct the RLC SDU by including, in the RLC SDU, either the first one or more octets from the first segment or the first one or more octets from the second segment.

### BRIEF DESCRIPTION OF THE FIGURES

Further features and advantages of the present invention will be apparent from the following detailed description, taken in combination with the appended drawings, in which:

FIG. 1 illustrates a schematic representation of a conventional disaggregated RAN node and entities implement layers of the radio link protocol stack.

FIG. 2 illustrates a representation of conventional RLC operations.

FIG. 3 illustrates a conventional model for robust uplink wireless communications.

FIG. 4A illustrates a decomposed RLC model for uplink wireless transmissions in accordance with one embodiment of the present invention.

FIG. 4B illustrates a decomposed RLC model for downlink wireless transmissions in accordance with one embodiment of the present invention.

FIG. 5 illustrates, in one embodiment, a RLC multi-link group model.

FIG. 6 illustrates a conventional RLC data PDU.

FIG. 7 illustrates a conventional MAC data PDU.

FIGS. 8A and 8B illustrate example embodiments of multi-link segmentation and reassembly.

FIG. 9 illustrates an example embodiment of RLC reception component operations.

FIG. 10 illustrates an example embodiment of RLC reassembly component operations.

FIG. 11 illustrates, in one embodiment, a method of reconstructing a RLC service data unit (SDU) in a wireless communication network.

FIG. 12 illustrates, in one embodiment, a block diagram of an electronic device (ED) illustrated within a computing and communications environment.

FIG. 13 illustrates, in one embodiment, an architecture for implementation of a Next Generation Radio Access Network (NG-RAN).

Throughout the appended drawings, like features are identified by like reference numerals.

### DETAILED DESCRIPTION

Embodiments of the present invention provide advantages by way of mechanisms for reducing latencies associated with the reliable transmission of data over multiple radio links. In particular, this disclosure describes a latency-reduction mechanism associated with the reconstruction of an error-free radio link control (RLC) service data unit (SDU) that has been segmented for transmission over two or more radio links.

As used herein, an RLC SDU comprises information received by an RLC transmitter entity from an upper layer protocol entity (such as a transmitting PDCP entity). The RLC SDU which comprise information is transmitted across a radio link, using a RLC protocol, to a RLC receiver entity for delivery to a corresponding upper layer protocol entity (such as a receiving PDCP entity). An RLC protocol data unit (PDU) comprises information transmitted from an RLC transmitter entity to a RLC receiver entity. In some instances, a RLC SDU may be transmitted across a radio link in a single RLC data PDU. In other instances, a RLC SDU may be divided into multiple segments by an RLC transmitter entity such that different RLC SDU segments are transmitted across a radio link in different RLC data PDUs; the RLC receiver entity reassembles the RLC SDU from the multiple RLC SDU segments (received in multiple RLC data PDUs) before delivering the reassembled RLC SDU to the upper layer protocol entity.

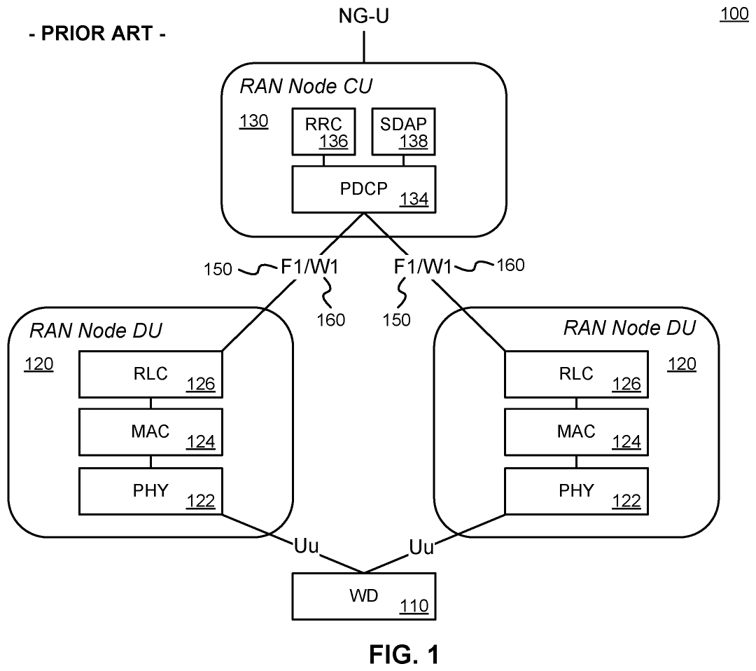

FIG. 1 illustrates a schematic representation 100 of a conventional disaggregated RAN node and entities that implement layers of the radio link protocol stack. In a disaggregated RAN node, the radio link protocol stack is split between a RAN node central unit (CU) 130 and a RAN node distributed unit (DU) 120. As illustrated in FIG. 1, a RAN node CU 130 includes entities that implement the upper layers of the protocol stack, including an entity that implements a Radio Resource Control layer (hereinafter referred to a RRC entity) 136, an entity that implements a Service Data Adaptation Protocol layer (hereinafter referred to as a SDAP entity) 138 and an entity that implements a Packet Data Convergence Protocol layer (referred to hereinafter as a PDCP entity) 134 while a RAN node DU 120 includes entities that implement the lower layers of the protocol stack, including an entity that implements the Radio Link Control layer (hereinafter referred to as a RLC entity) 126, an entity that implements a Medium Access Control layer (hereinafter referred to as a MAC entity) 124 and an entity that implements a physical layer (referred to hereinafter as a PHY entity) 122. In a disaggregated RAN node, one or more RAN node DUs may be associated with a RAN node CU with each RAN node DU 120 connected to a RAN node CU 130 through an interface known as F1 150 or W1 160. For the purposes of the present application, an entity that implements a layer of the protocol stack may be software or hardware developed for protocol processing.

As used herein, the term “entity” or “component” may refer to a networked electronic device or portion thereof. The portion (e.g. referred to as entity or component) of an electronic device may include hardware, software, or both. The electronic device may be for example located in a core or access portion of a communication network. The electronic device may include a computer processor and memory or other electronic hardware and may include a non-transitory memory storing instructions that, when executed by the computer processor, cause the electronic device to perform operations associated with the entity or component. In some cases the electronic device may include electronic hardware that performs operations associated with a given entity or component. Different entities or components can be operatively coupled via wired, wireless or optical communication links. Multiple entities can be instantiated in the same physical hardware. In some cases, an entity or component (e.g. an entire networked electronic device) can be distributed across multiple hardware elements, for example in the case of virtualization or instantiation within a datacentre. In some cases, where explicitly stated or otherwise implied, different components can reside in different physical hardware, such as in the case of a PDCP component (an example of an entity) residing in a CU and an RLC component residing in a DU.

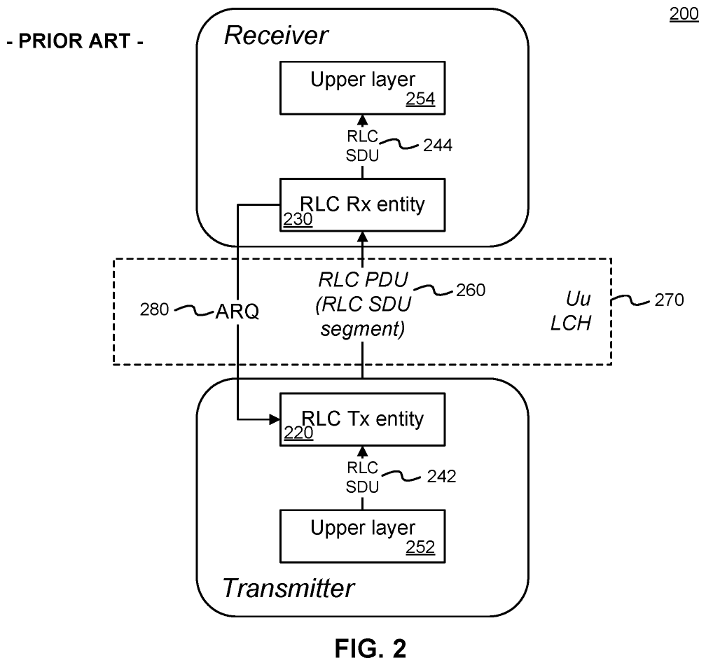

FIG. 2 illustrates a representation 200 of conventional RLC operations. An RLC entity, which includes an RLC transmitter (Tx) entity 220 and a peer RLC receiver (Rx) entity 230, is responsible for adapting a service data unit (SDU) 242 received from an entity that implements an upper layer of the protocol stack (referred to hereinafter as an upper layer entity 252) for transmission over the radio link via the MAC and PHY entities (not shown). In particular, the RLC Tx entity 220 may divide the SDU 242 received from the upper layer entity 252 into one or more RLC SDU segments, where each RLC SDU segment is encapsulated in an RLC protocol data unit (PDU) 260 in order to adapt to a PHY transport block (TB) allocation provided by the MAC entity. Throughout this specification, an RLC PDU and an RLC SDU segment may be referred to using the same reference number, e.g. 260. This reflects the situation that the RLC SDU segment is encapsulated in the corresponding RLC PDU. The peer RLC Rx entity 230 is responsible for reconstructing the RLC SDU from the RLC SDU segments 260 received over the Uu radio link 270 and generate a reconstructed error-free RLC SDU 244.

If a RLC SDU segment 260 is lost in transmission over the radio link (e.g. due to interference or due to an obstruction), the RLC reception entity 230 may request retransmission of the missing RLC SDU segment through an automatic repeat request (ARQ) 280. A reconstructed SDU 244 is only forwarded to the upper layer entity 254 by the RLC reception entity 230 if all RLC SDU segments have been received error-free.

A conventional RLC entity communicates with a peer RLC entity over a logical channel (LCH) 270 that may be configured by an upper layer control plane entity. An RLC entity in a WD may be configured by a RAN node using radio resource control (RRC) signalling. If an RLC LCH is configured for assured mode (AM) of operation, an RLC reception entity will attempt to recover missing RLC SDU segments through ARQ. If an RLC logical channel is configured for unassured mode (UM) of operation, an RLC reception entity will not attempt to recover missing RLC SDU segments. If an error-free RLC SDU cannot be reconstructed within a certain period of time, a partially received RLC SDU will be discarded and nothing is forwarded by the RLC reception entity.

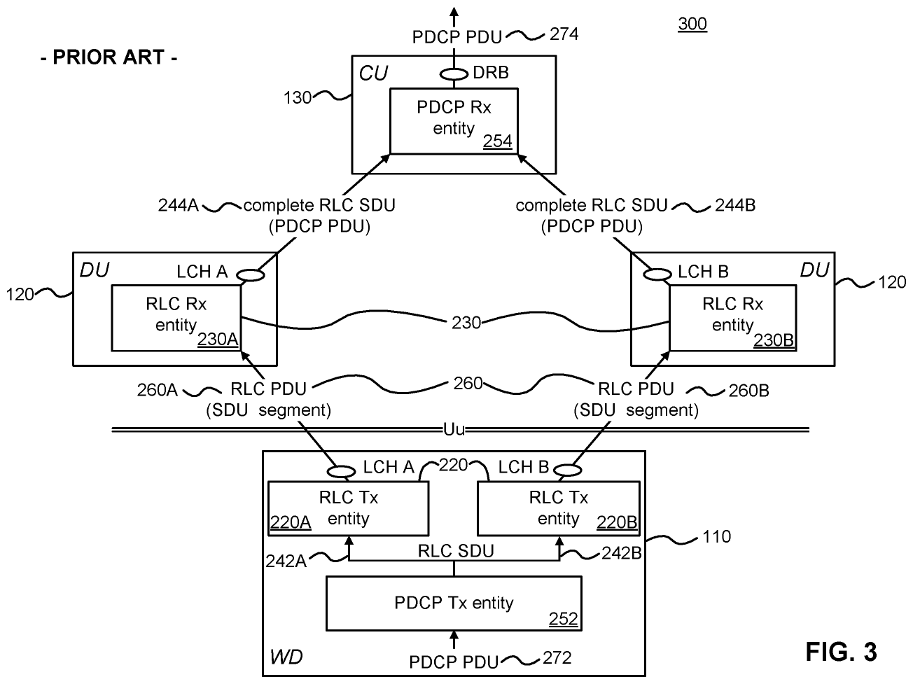

FIG. 3 illustrates a model 300 of a conventional communication network for robust wireless communications. In some situations, high reliability and low latency may be required for wireless transmissions between a RAN node and a WD. This can be accomplished by contemporaneously transmitting multiple copies of an RLC SDU across two or more radio links. The term “model” in this context refers to a schematic diagram illustrating a device or system architecture, and in this case the communication network includes a RAN node communicating with a WD.

In the conventional model 300 illustrated in FIG. 3, for communications over the uplink between a WD 110 and one or more RAN node DUs, an upper layer PDCP transmitter (Tx) entity 252 in the WD provides a copy of a PDCP PDU 272 as an RLC SDU (e.g. 242A and 242B) to each of two or more RLC transmitter (Tx) entities. Only one disaggregated RAN node is illustrated in FIG. 3. Each RLC Tx entity (e.g. 220A and 220B, generally referred to as RLC Tx entity 220 and collectively as RLC Tx entities 220), responsible for uplink transmissions over one of the radio links, segments the SDU if necessary and transmits each segment over its configured logical channel as an RLC data PDU (e.g. 260A and 260B, generally referred to as RLC data PDU 260 and collectively as RLC data PDUs 260).

In the RAN, there is an upper layer PDCP receiver (Rx) entity 254 that is responsible for processing PDCP PDUs associated with a data radio bearer (DRB) or a signalling radio bearer (SRB). The PDCP receiver entity 254 is affiliated with multiple RLC receiver (Rx) entities and may be situated at a central location such as a RAN node CU 130. Each RLC Rx entity (e.g. 230A and 230B, generally referred to as RLC Rx entity 230 and collectively as RLC Rx entities 230) is responsible for uplink transmissions received over one of the radio links; an RLC Rx entity 230 may be situated at a location different from the PDCP entity 254 such as a RAN node DU 120.

Each RLC Rx entity 230 operates independently of the other RLC Rx entities and forwards an RLC SDU 244 (i.e. a PDCP PDU 274) to the PDCP Rx entity 254 once the RLC Rx entity 230 has completed reconstruction of a (possibly) segmented RLC SDU. The PDCP Rx entity 254 uses a sequence number associated with each PDCP PDU 274 to ignore replicated PDCP PDUs that it may receive.

If an RLC Rx entity 230 cannot reconstruct a complete error-free RLC SDU 244, nothing is forwarded to the PDCP Rx entity 254 by that RLC Rx entity.

Conventionally, each RLC Rx entity 230 attempts to independently reconstruct a complete error-free RLC SDU 244, possibly using ARQ to recover any lost RLC SDU segments 260. Therefore, processing of a PDCP PDU 274 by the PDCP Rx entity 254 is delayed until reconstruction of an error-free RLC SDU 244 has been completed by (at least) one of the RLC Rx entities 230.

If none of the RLC Rx entities 230 can reconstruct an error-free RLC SDU 244, then nothing is forwarded to the PDCP Rx entity 254 and all of the received RLC SDU segments 260 are discarded; this may occur even if a RLC SDU segment lost on one radio link was successfully received over a different radio link.

Embodiments of the present invention exploit the possibility that an RLC SDU segment lost when transmitted over one radio link may have been successfully received over another radio link. RLC SDU segments are used for reconstruction of a complete error-free RLC SDU regardless of which radio link was used to receive the segment. By reassembling RLC SDUs based on RLC SDU segments received over potentially multiple different radio links, performance indicators such as latency, spectral efficiency (due to reduced retransmissions) and packet loss rates can be potentially improved.

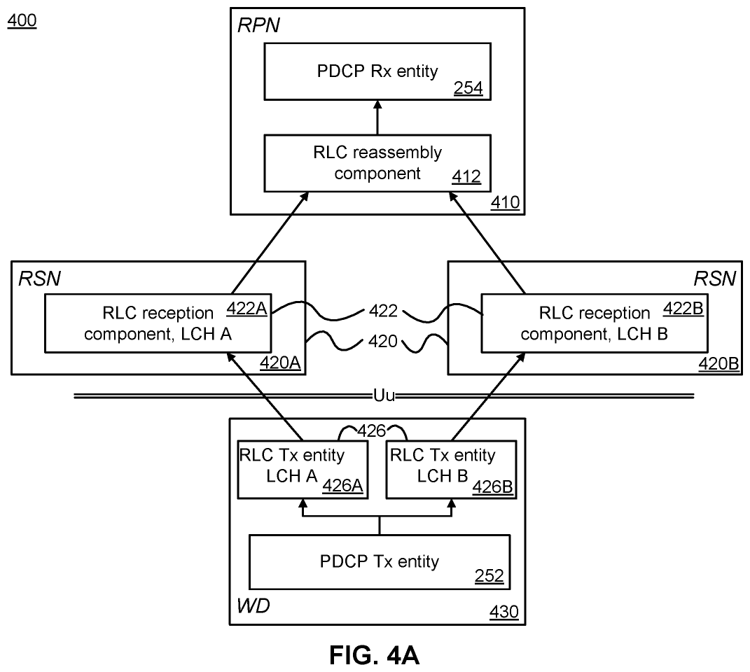

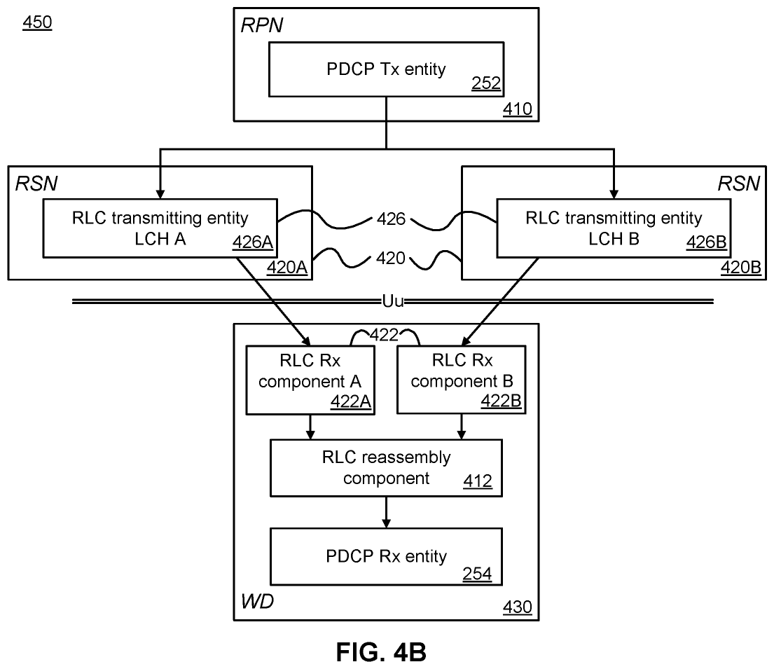

In embodiments herein, an RLC receiver (Rx) entity 230 is decomposed into two components: an RLC reassembly component, and two or more RLC reception components. As illustrated in FIGS. 4A and 4B, each RLC reception component (e.g. 422A and 422B, generally referred to as RLC reception component 422 and collectively as RLC reception components 422) is associated with one of the radio links and, for a RAN RLC reception component, may be situated at a distributed location in a RAN secondary node (RSN) (e.g. 420A and 420B, generally referred to as RSN 420 and collectively as RSNs 420) such as a RAN node distributed unit (DU). As RLC SDU segments are correctly received by an RLC reception component 422, they are forwarded to the RLC reassembly component 412. If an RLC SDU segment is lost during transmission over the radio link, the associated RLC reception component 422 may perform ARQ to recover the lost segment; ARQ results in a forwarding delay for the lost RLC SDU segment but not for RLC SDU segments that are correctly received. Each RLC reception component 422 operates independently of other RLC reception components, making independent decisions for RLC SDU segment forwarding and ARQ error recovery. Consequently, ARQ may be performed independently for different RLC SDU segments in different RLC reception components.

An RLC reassembly component 412 is associated with a radio bearer and, for a RAN RLC reassembly component, may be situated at a central location in a RAN primary node (RPN) 410 such as a RAN node centralized unit (CU). A RLC reassembly component 412 is responsible for reconstructing an error-free RLC SDU from RLC SDU segments forwarded by the RLC reception components 422; once an error-free RLC SDU has been reconstructed, the RLC SDU is forwarded to an upper layer entity, such as a PDCP Rx entity 254. More generally, the reconstructed RLC SDU can be forwarded to an entity in the wireless network configured to receive and handle (e.g. process or forward) the RLC SDU (or the corresponding PDCP PDU) as a unit of data. In this context, a unit of data refers to data which is processed or forwarded as a group and treated as a single entity for such processing or forwarding purposes, for example as in the case a packet or data unit.

FIG. 4A illustrates, in one embodiment, a decomposed RLC model 400 for uplink wireless transmissions. FIG. 4A illustrates, in particular, a RAN RLC Rx entity in accordance with an embodiment for uplink transmissions from a WD to a RAN. The term “model” in this context refers to a schematic diagram illustrating a device or system architecture. For reliable uplink transmission of an RLC SDU, an upper layer entity in WD 430 (such as a PDCP transmitter entity 252) forwards a copy of the RLC SDU to two or more RLC transmitter entities (e.g. 426A and 426B, generally referred to as RLC transmitter entity 426 and collectively as RLC transmitter entities 426). Each RLC transmitter entity 426 is associated with a logical channel (LCH) for transmitting RLC PDUs across a radio link to a corresponding RLC reception component 422 within the RAN. The RLC reception components 422 within the RAN may be co-located within a RAN node or may be located in different RAN nodes such as an RSN 420A, 420B. Each RLC transmitter entity 426 segments (e.g. divides) the RLC SDU into one or more RLC SDU segments and transmits each RLC SDU segment in an RLC data PDU to its corresponding RLC reception component 422. Each RLC SDU segment may be transmitted in a different respective RLC PDU, e.g. using encapsulation. If an RLC reception component 422 does not correctly receive a RLC SDU segment, it may use ARQ to request retransmission of the RLC SDU segment by the corresponding RLC transmitter entity 426. When an RLC reception component 422 correctly receives an RLC SDU segment, the RLC segment is immediately forwarded by the RLC reception component 422 to the RLC reassembly component 412 associated with the LCH. The RLC reception component 422 may determine that the RLC SDU segment is correctly or incorrectly received by processing the RLC PDU containing the RLC SDU segment.

The RLC reassembly component 412 may be co-located with one or more of the RLC reception components 422 or may be located in a different RAN node such as an RPN 410. As the RLC reassembly component 412 receives RLC SDU segments associated with the RLC SDU from the two or more RLC reception components 422, it attempts to assemble an error-free RLC SDU using the received RLC SDU segments. When the RLC reassembly component 412 completes assembly of an error-free RLC SDU, the reassembled RLC SDU is forwarded to an upper layer entity in the RAN (such as a PDCP receiver entity 254) for further processing.

FIG. 4B illustrates, in one embodiment, a decomposed RLC model 450 for downlink wireless transmissions. FIG. 4B illustrates, in particular, a WD RLC Rx entity in accordance with an embodiment for downlink transmissions from a RAN to a WD. The term “model” in this context refers to a schematic diagram illustrating a device or system architecture. For reliable downlink transmission of an RLC SDU, an upper layer entity in the RAN (such as a PDCP transmitter entity 252), which may be located in a RAN node such as an RPN 410, forwards a copy of the RLC SDU to two or more RLC transmitter entities 426. The RLC transmitter entities 426 within the RAN may be co-located within a RAN node or may be located in different RAN nodes such as an RSN 420A, 420B. Each RLC transmitter entity 426 is associated with a logical channel (LCH) for transmitting RLC PDUs across a radio link to a corresponding RLC reception component 422 within a WD 430. Each RLC transmitter entity 426 divides the RLC SDU into one or more RLC SDU segments and transmits each RLC SDU segment in an RLC data PDU to its corresponding RLC reception component 422. If an RLC reception component 422 does not correctly receive an RLC SDU segment, it may use ARQ to request retransmission of the RLC SDU segment by the corresponding RLC transmitter entity 426. When an RLC reception component 422 correctly receives an RLC SDU segment, the RLC segment is immediately forwarded by the RLC reception component 422 to the RLC reassembly component 412 associated with the LCH. As the RLC reassembly component 412 receives segments associated with the RLC SDU from the two or more RLC reception components 422, it attempts to assemble an error-free RLC SDU using the received RLC SDU segments. When the RLC reassembly component 412 completes assembly (i.e. reconstruction) of an error-free RLC SDU, the reassembled RLC SDU is forwarded to an upper layer entity in WD 430 (such as a PDCP receiver entity 254) for further processing.

Since it is possible that an RLC SDU segment that has been lost during transmission over one radio link has been successfully received over another radio link, reconstruction of the RLC SDU (e.g. assembly of an error-free RLC SDU) may not be impacted by delays normally associated with ARQ error recovery. Correctly received RLC SDU segments from different RLC reception components can be combined by the RLC reassembly component thus allowing one RLC reception component to provide RLC SDU segments that may not have been correctly received by other RLC reception components. As a consequence, latency associated with RLC SDU (i.e. PDCP PDU) reconstruction and forwarding can be reduced. Because RLC reception components forward RLC SDU segments as they are received rather than waiting for the entire RLC SDU to be successfully received, latency is further reduced. This leads to potential performance improvements as discussed above.

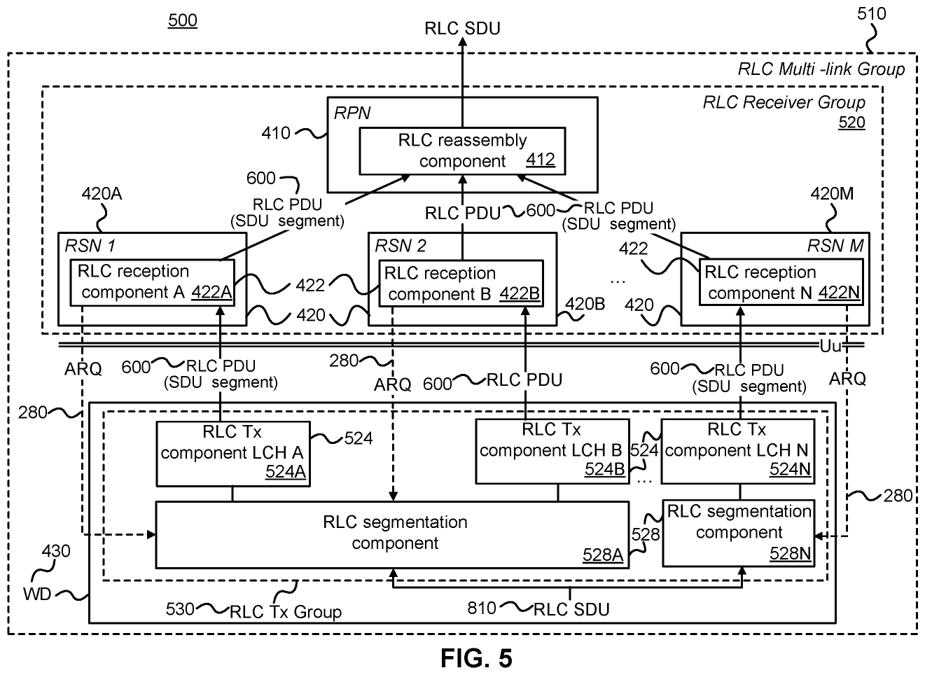

FIG. 5 illustrates, in one embodiment, a RLC multi-link group model 500 corresponding to the uplink RLC model 400 of FIG. 4A. The term “model” in this context refers to a schematic diagram illustrating a device or system architecture. In embodiments herein, an RLC multi-link group (MLG) 510 encompasses the network resources required to convey an RLC SDU across multiple radio links in order to improve reliability of wireless communications. Within the RLC MLG, N (N>1) RLC transmitting entities 426 of an RLC transmitter group 530 are coupled to N RLC reception components 422 of an RLC receiver group 520. In addition, the RLC receiver group 520 includes one or more RLC reassembly components 412 that are coupled to one or more of the RLC reception components 422 in the RLC receiver group 520. The RLC receiver group 520 may include one or more RSNs such as RSN 1 420A, RSN 2 420B, and RSN M 420M with each RSN 420 hosting one or more RLC reception components 422. The RLC receiver group 520 may include one or more RPNs 410 with each RPN 410 hosting one or more RLC reassembly components 412. Each RLC reassembly component 412 may be associated with one or more radio bearers.

Each of the N RLC transmitting entities 426 may include an RLC segmentation component 528 (e.g. 528A and 528N, generally referred to as RLC segmentation component 528 and collectively as RLC segmentation components 528) and an RLC transmission (Tx) component 524 (e.g. 524A, 524B and 524N, generally referred to as RLC transmission component 524 and collectively as RLC transmission components 524). An RLC transmitter group 530 may include one or more RLC segmentation components 528. In one embodiment, one RLC segmentation component (e.g. 528A) may be associated with multiple RLC transmission components (e.g. 524A and 524B). In another embodiment, an RLC transmission component (e.g. 524N) may be associated with a dedicated RLC segmentation component (e.g. 528N). Each of the N RLC transmission components 524 is coupled over a Uu radio link to one of the N RLC reception components 422 through an RLC logical channel (LCH) dedicated for use by that transmitter-receiver pair. Each RLC reception component 422 can independently request retransmission of an RLC SDU segment by the corresponding RLC transmitting entity using ARQ 280.

In one embodiment, an ARQ is processed within the RLC transmitter group 530 by the RLC segmentation component 528 associated with the corresponding LCH and RLC transmission component 524. In another embodiment, an ARQ is processed by the RLC transmission component 524 associated with the corresponding LCH.

A similar RLC multi-link group (not shown) can be configured for transmission in the downlink direction corresponding to the decomposed RLC model 450 of FIG. 4B. For a RAN RLC transmitter group, an RLC transmission component 524 and associated RLC segmentation component 528 may be situated at a distributed location in a RAN secondary node (RSN) 420 such as a RAN node DU or a RAN node serving a secondary cell group (SCG).

For uplink transmissions, within the RAN, an RLC reassembly component 412 may be situated within a RAN primary node (RPN) 410 such as a next generation RAN (NG-RAN) centralised unit (CU) or a RAN node serving a master cell group (MCG). Similarly, an RLC reception component may be situated within a RAN secondary node (RSN) 420 such as an NG-RAN distributed unit (DU) or a RAN node serving a secondary cell group (SCG). In some instances, multiple RLC reception components may be situated within the same RSN. In some instances, multiple RLC reassembly components may be situated within the same RPN or within different RPNs. In some instances, one or more RSNs may be collocated with an RPN. If an RSN is not collocated with its associated RPN, RLC data PDUs may be forwarded from the RSN to the RPN over a transport network layer (TNL) using a protocol such as F1.

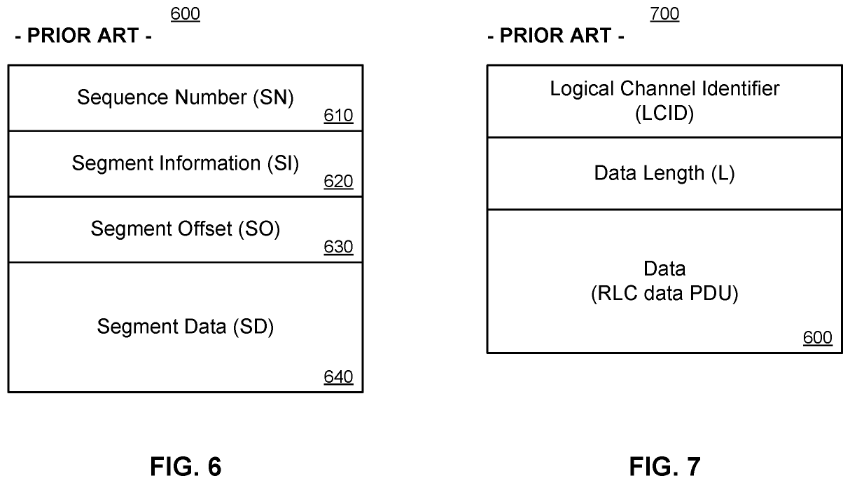

FIG. 6, in one embodiment, illustrates a RLC data PDU 600 that may be used to exchange information between an RLC transmitting entity and an RLC reception component using the conventional RLC protocol.

A RLC data PDU 600 exchanged over a radio link between an RLC transmitting entity and an RLC reception component includes the following information elements:
sequence number (SN) 610 is used to identify the RLC SDU associated with the segment data contained in the RLC data PDU 600.
segment information (SI) 620 indicates the type of segment contained in the RLC data PDU; this may be one of the following:
   the segment data field contains the only segment of an RLC SDU (i.e. the RLC SDU is not segmented);
   the segment data field contains the first segment of an RLC SDU;
   the segment data field contains the last segment of an RLC SDU;
   the segment data field contains neither the first nor last segment of an RLC SDU.

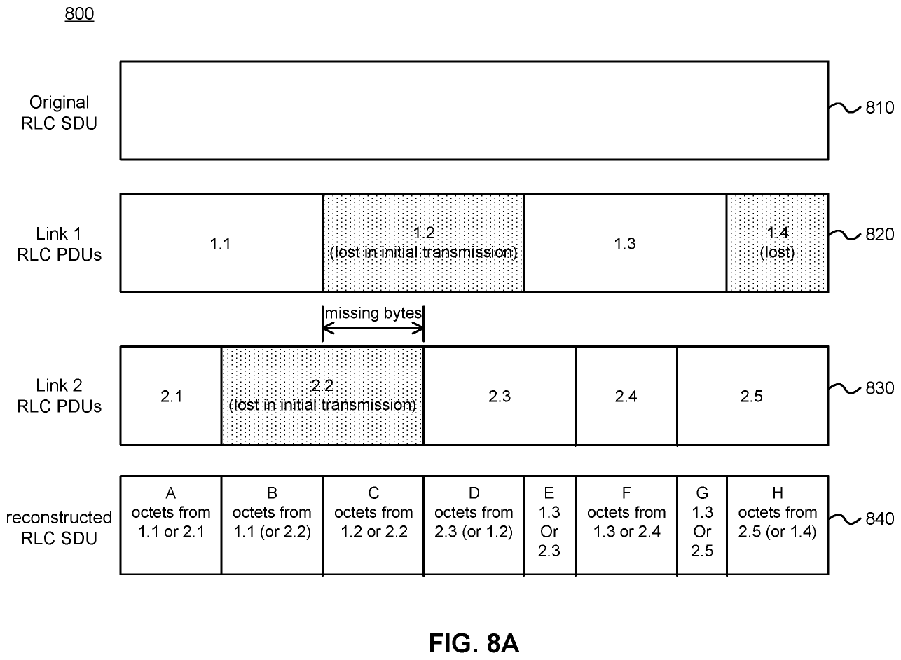

segment offset (SO) 630 indicates the starting position of this segment relative to the first octet of the RLC SDU, where the first octet is at position zero. The SO field is not included in an RLC PDU if the SI field indicates that this is the first or the only segment of an RLC SDU.
segment data (SD) 640 field comprises the octets associated with the indicated segment. The number of octets in the SD field is determined from a length field (L) in the MAC data PDU 700 used to convey the RLC data PDU 600 over the radio link, with the conventional MAC data PDU structure as illustrated in FIG. 7.

In various embodiments, each RLC data PDU 600 can include an indication of which octets of the overall RLC SDU are contained in the segment included in the RLC data PDU 600. This indication can be provided in the form of the SN and SI, or the SN, SI and SO, for example. Embodiments of the present invention then further include reconstructing the RLC SDU to include all of its octets, based on the indications included in each of the RLC data PDUs 600.

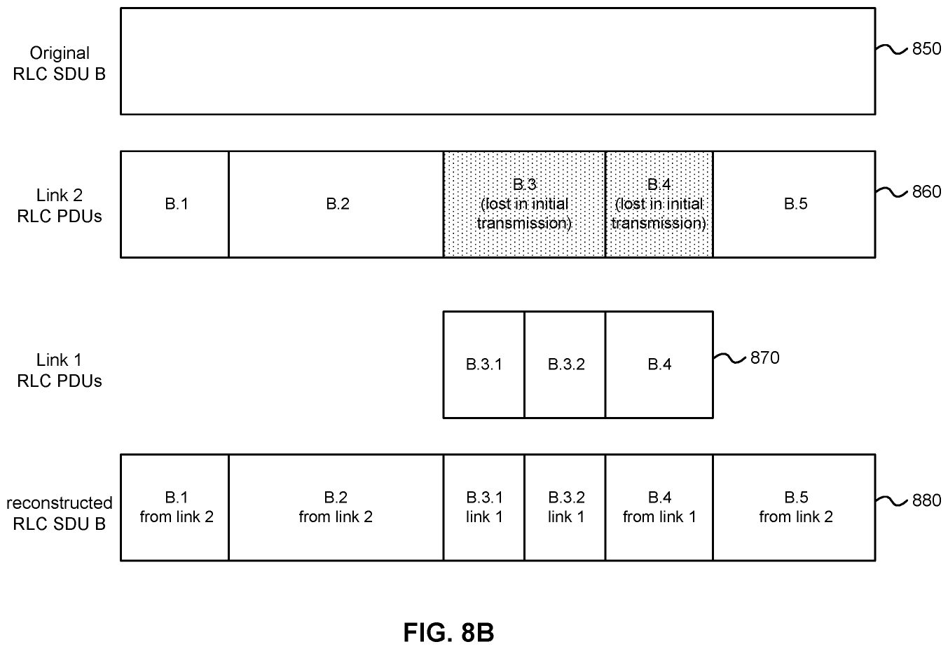

FIGS. 8A and 8B illustrate example embodiments of multi-link segmentation and reassembly. In some instances, multiple copies of an RLC SDU may be contemporaneously transmitted over different radio links of an MLG 510 to increase reliability. When a copy of the RLC SDU must be segmented by RLC segmentation component 528 for transmission by RLC transmission component 524 over a particular radio link, each RLC SDU segment is included as segment data 640 in an RLC data PDU 600. The RLC segmentation component 528 associated with each radio link makes independent decisions on how to segment its copy of the RLC SDU based, for example, on signal quality and available radio resources on its associated radio link. As a result, different copies of an RLC SDU may be segmented differently on different radio links.

In addition, the RLC reception component associated with each radio link operates independently when attempting to recover RLC SDU segments that have been lost in transmission over the radio link. If a logical channel has been configured for operation in an assured mode (AM), an RLC reception component will use ARQ to try to recover a lost RLC SDU segment even though (a portion of) the RLC SDU segment may have already been correctly received by an RLC reception component associated with a different radio link. An RLC reception component will, however, immediately forward RLC SDU segments to its RLC reassembly component as they are received.

Independence of the radio links also allows higher throughput radio links to be used in parallel with lower throughput links without coupling between RLC transmitter entities. For example, a radio link with a high signal to interference ratio (SIR) may be able to increase throughput by using a higher rate modulation and coding scheme (MCS) compared to a radio link experiencing lower SIR. This may also result in different sizes for segments used on the two radio links. The decision on MCS and segment size may be made independently by the different RLC transmitter entities without affecting operations at the corresponding RLC reception components or at the RLC reassembly component. The RLC reassembly component simply uses the first instance of a received octet for reconstruction of an RLC SDU, regardless of the radio link where the octet was received.

An SDU identifier (SID) is assigned to an RLC SDU by the RLC transmitter group before copies are created to ensure that the same SID appears in the SN field of each RLC data PDU associated with the RLC SDU regardless of the radio link used to convey the RLC data PDU, via an RLC reception component, to the RLC reassembly component. The SID must be unique across all RLC SDUs that are currently being processed within the RLC MLG. The SID may, for example, be based on a counter maintained by the RLC transmitter group or may be based on an identifier associated with an upper layer PDU; for example, the SID may be derived from the sequence number associated with a PDCP data PDU that is being conveyed across the Uu interface as an RLC SDU. A SID may be reused if an RLC SDU previously associated with that SID is no longer being processed due, for example, to successful completion of the RLC SDU reconstruction or to aborting of the RLC SDU reconstruction due to an unrecoverable radio link failure.

In the example of FIG. 8A, an RLC SDU 810 is contemporaneously transmitted over two radio links to increase reliability. The RLC transmitter entity associated with radio link 1 generates four segments 820 contained in RLC data PDUs 1.1, 1.2, 1.3 and 1.4; the RLC transmitter entity associated with radio link 2 generates five segments 830 contained in RLC data PDUs 2.1, 2.2, 2.3, 2.4 and 2.5.

During initial transmission over their respective radio links, RLC data PDUs 1.2 and 1.4 and RLC data PDU 2.2 are lost. Independently, each of the associated RLC reception components may use ARQ to recover the lost segments. Reconstruction of the RLC SDU by the RLC reassembly component would be delayed until an error-free RLC data PDU 1.2 or 2.2 is received by one of the RLC reception components, however reconstruction is not delayed waiting for recovery of lost RLC data PDU 1.4 since those octets had been successfully received in RLC data PDU 2.5.

A given octet may be received by the RLC reassembly component from different reception components at different times. As a result, the reconstructed RLC SDU 840 may be assembled from the following fragments:
fragment A containing octets from RLC data PDU 1.1 or 2.2, whichever RLC data PDU was received first by the RLC reassembly component.
fragment B containing octets likely from RLC data PDU 1.1 since RLC data PDU 2.2 was lost during an initial transmission. If the logical channel on radio link 2 has higher throughput than the logical channel on radio link 1, it is possible that octets from RLC data PDU 2.2 could be used for fragment B if ARQ on radio link 2 was successful completed before RLC data PDU 1.1 was forwarded to the RLC reassembly component.
fragment C containing octets from either RLC data PDU 1.2 or RLC data PDU 2.2. Since both RLC data PDU 1.2 and RLC data PDU 2.2 were lost during an initial transmission, the octets used by the RLC reassembly component depends on which RLC reception component is first to complete recovery of its RLC data PDU through ARQ and to forward the received segment data to the RLC reassembly component.
fragment D containing octets likely from RLC data PDU 2.3 since RLC data PDU 1.2 was lost during an initial transmission.
fragment E containing octets from either RLC data PDU 1.3 or RLC data PDU 2.3.
fragment F containing octets from either RLC data PDU 1.3 or RLC data PDU 2.4.
fragment G containing octets from either RLC data PDU 1.3 or RLC data PDU 2.5.
fragment H containing octets likely from RLC data PDU 2.5 since RLC data PDU 1.4 was lost during an initial transmission.

The RLC reassembly component may be configured to identify available fragments and reconstruct an RLC SDU based on the available fragments. The RLC SDU can be reconstructed once all of the octets, equalling the RLC SDU length, are available at the RLC reassembly component. The availability of different octets can be determined based on the information provided in each of the received RLC data PDUs 600, such as SN, SI and SO information as illustrated for example in FIG. 6. The length of the RLC SDU can be determined from the segment offset (SO) 630 and segment length (L) associated with the RLC data PDU 600 where the segment information (SI) 620 indicates the RLC data PDU segment data (SD) 640 contains the last segment of the RLC SDU.

If the RLC SDU can be transmitted in a single PHY transport block (TB), it is not necessary to segment the RLC SDU and the RLC SDU can be transmitted in a single RLC data PDU where the segment information (SI) indicates that the segment data (SD) contains the only segment of the RLC SDU. In this case, the RLC reassembly component can forward the first copy of the RLC SDU that it receives.

In some instances, different RLC data PDUs may be contemporaneously transmitted over different radio links of an MLG 510 to increase throughput or to provide load balancing. Selection of the radio link (and its associated RLC transmission component such as 524A and 524B) to be used for transmission of an RLC data PDU is performed by the RLC segmentation component (such as 528A). Several criteria may be used to determine which radio link should be selected for initial transmission of an RLC data PDU; for example:
if there is a low volume of data queued for transmission by the RLC transmitter entity, the radio link with the best signal quality may be selected;
if there is a high volume of data queued for transmission by the RLC transmitter entity, the radio link with the largest available PHY transport block may be selected;
if load balancing or rate control is required, the radio link with the largest number of credits in its transmission bucket may be selected.

If an RLC data PDU (i.e. an RLC SDU segment) is lost during transmission over a radio link, the associated RLC reception component 422 may perform ARQ to recover the lost segment. Within the RLC transmitter entity, ARQ 280 requests are handled by the RLC segmentation component 528 which may decide to retransmit the lost RLC SDU segment via the same radio link or via a different radio link. If necessary, the retransmitted RLC SDU segment may be re-segmented by the RLC segmentation component 528 and the resulting RLC data PDUs may be transmitted via the same or via different radio links.

Since the SDU identifier (SID) assigned to an RLC SDU by the RLC transmitter group must be unique across all RLC SDUs that are currently being processed within the RLC MLG, the RLC reassembly component in the RLC receiver entity is able to use the RLC SDU segments received via any of the RLC reception components to reassemble the RLC SDU.

In the example of FIG. 8B, two RLC SDUs—RLC SDU A (not shown) and RLC SDU B 850—are contemporaneously transmitted over different radio links to increase throughput. The RLC segmentation component 528A generates four segments for RLC SDU A contained in RLC data PDUs A.1, A.2, A.3 and A.4 (not shown). The RLC segmentation component 528A generates five segments for RLC SDU B 850 contained in RLC data PDUs B.1, B.2, B.3, B.4 and B.5 (860). RLC SDU A (i.e. RLC data PDUs A.1, A.2, A.3 and A.4) is forwarded to RLC transmission component 524A for initial transmission over radio link 1 and RLC SDU B 860 (i.e. RLC data PDUs B.1, B.2, B.3, B.4 and B.5) is forwarded to RLC transmission component 524B for initial transmission over radio link 2.

RLC data PDUs B.3 and B.4 are lost in transmission (860) and RLC reception component 422B sends an ARQ requesting retransmission of the lost RLC SDU segments. Due to poor signal conditions on radio link 2, the RLC segmentation component 528A selects RLC transmission component 524A for re-transmission of the lost RLC data PDUs over radio link 1. In addition, the RLC segmentation component 528A re-segments RLC data PDU B.3 into two RLC data PDUs B.3.1 and B.3.2 (870) for transmission over radio link 1. As a result, the RLC reassembly component 412 may reconstruct RLC SDU B from the following segments (880):
segment B.1 containing octets received from the RLC reception component 422B associated with radio link 2.
segment B.2 containing octets received from the RLC reception component 422B associated with radio link 2.
segment B.3.1 containing octets received from the RLC reception component 422A associated with radio link 1.
segment B.3.2 containing octets received from the RLC reception component 422A associated with radio link 1.
segment B.4 containing octets received from the RLC reception component 422A associated with radio link 1.
segment B.5 containing octets received from the RLC reception component 422B associated with radio link 2.

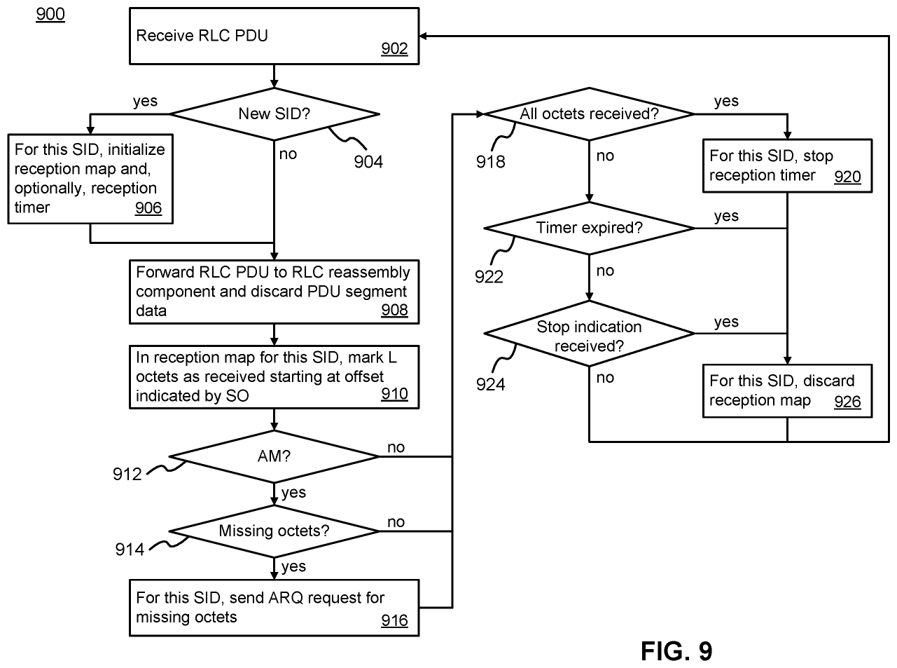

FIG. 9 illustrates an example embodiment of RLC reception component operations 900.

At operation 902, a RLC reception component receives an RLC data PDU 600 from a lower layer MAC entity. The MAC entity also identifies the logical channel (LCD) and the length (L) included in the MAC data PDU 700 associated with the RLC data PDU 600.

At operation 904, the RLC reception component determines whether, for the indicated LCID, the SID included in the SN 610 of the RLC data PDU 600 is associated with a RLC SDU that is currently being processed by the RLC reception component.

At operation 906, if there is no RLC SDU being processed that corresponds to the SID, the RLC reception component initialises a reception map indicating that none of the octets for the RLC SDU corresponding to the SID have been received. Optionally, the RLC reception component may also initialise an RLC reception timer associated with the RLC SDU corresponding to the SID.

At operation 908, the RLC reception component forwards the RLC data PDU 600 to the RLC reassembly component. After successful forwarding, the RLC data PDU segment data (SD) 640 may be discarded.

At operation 910, in the reception map associated with the RLC SDU corresponding to the SID, the RLC reception component indicates that L octets have been received starting at the offset indicated by SO 630 in the RLC data PDU 600.

At operation 912, the RLC reception component determines whether the LCID has been configured for assured mode (AM) of operation.

At operation 914, if the LCID has been configured for AM, the RLC reception component determines whether any octets are missing for the RLC SDU corresponding to the SID—e.g. whether there are any octets prior to the SO 630 that should have been received but have not been received.

At operation 916, if there are missing octets, the RLC reception component may send an ARQ to its peer RLC transmitting entity requesting retransmission of the missing octets for the indicated LCID and SID.

At operation 918, the RLC reception component determines, using the reception map, whether all octets associated with the RLC SDU corresponding to the SID have been received. The number of octets in the RLC SDU can be determined from an RLC data PDU where the segment information (SI) 620 indicates that this is the last or only segment associated with the RLC SDU.

At operation 920, if all octets associated with the RLC SDU corresponding to the SID have been received, the RLC reception component may stop the RLC reception timer associated with the RLC SDU corresponding to the SID if the timer was started in operation 906.

At operation 922, the RLC reception component determines whether the RLC reception timer associated with the RLC SDU corresponding to the SID has expired, if the timer was started in operation 906.

At operation 924, if the timer has not expired, the RLC reception component determines whether it has received a stop indication from the RLC reassembly component for the RLC SDU corresponding to the LCID and SID of this RLC SDU.

At operation 926, if all octets associated with the RLC SDU corresponding to the SID have been received, or if the RLC reception timer associated with the RLC SDU corresponding to the SID has expired, or if a stop indication corresponding to the RLC SDU corresponding to the SID has been received, the RLC reception component discards the reception map corresponding to the LCID and SID of this RLC SDU and the RLC reception component will generally stop reception operations for the RLC SDU corresponding to the SID.

At this point, the RLC reception component returns to operation 902 to await the arrival of the next RLC data PDU.

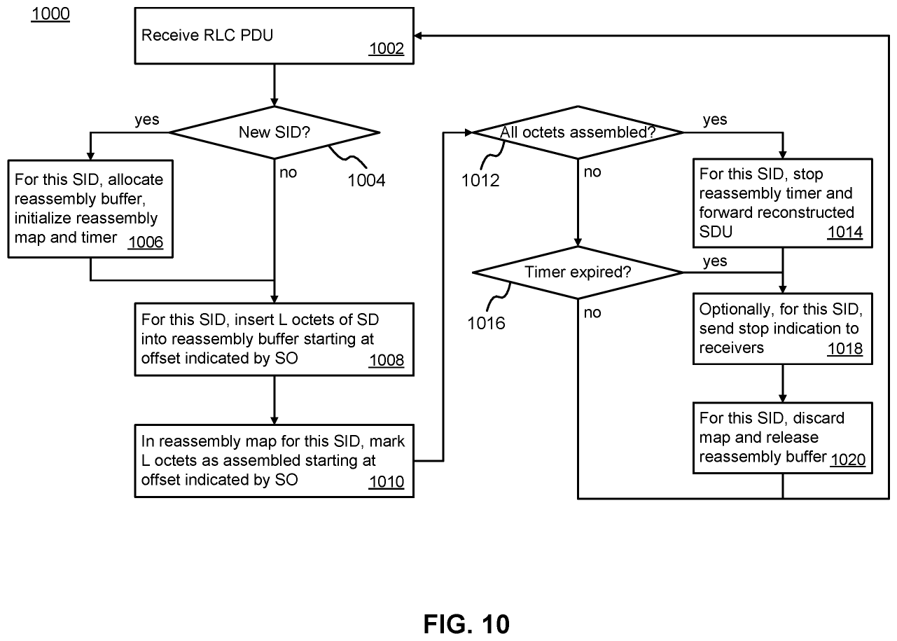

FIG. 10 illustrates an example embodiment of RLC reassembly component operations 1000.

At operation 1002, an RLC reassembly component receives an RLC data PDU 600 from an RLC reception component and determines the associated logical channel identifier (LCID) and length (L). Within the RAN, this may be determined, for example, from TNL information provided by the RLC reception component or from the MAC data PDU 700 carrying the RLC data PDU. Within a WD, this may be determined directly from the MAC data PDU 700 carrying the RLC data PDU. The LCID may be used by the RLC reassembly component to identify the corresponding MLG 510.

At operation 1004, the RLC reassembly component determines whether the SID included in the SN 610 of the RLC data PDU 600 is associated with a RLC SDU that is currently being processed for the MLG 510 by the RLC reassembly component.

At operation 1006, if there is no RLC SDU being processed that corresponds to the SID, the RLC reassembly component initialises a reassembly map indicating that none of the octets for the RLC SDU corresponding to the SID have been assembled. The RLC reassembly component may also allocate an RLC reassembly buffer and initialise an RLC reassembly timer for the RLC SDU corresponding to the SID.

At operation 1008, the RLC reassembly component inserts the L octets of segment data (SD) 640 from the RLC data PDU 600 into the reassembly buffer corresponding to the SID starting at the offset indicated by SO 630. In some situations, one or more octets in the received RLC data PDU 600 may have already been inserted into the reassembly buffer due, for example, to the previous arrival of an RLC data PDU from another RLC reception component.

At operation 1010, in the reassembly map associated with the RLC SDU corresponding to the SID, the RLC reassembly component indicates that L octets have been assembled starting at the offset indicated by SO 630 in the RLC data PDU 600.

At operation 1012, the RLC reassembly component determines, using the reassembly map, whether all octets associated with the RLC SDU corresponding to the SID have been assembled. The number of octets in the RLC SDU can be determined from an RLC data PDU 600 where the segment information (SI) 620 indicates that this is the last or only segment associated with the RLC SDU.

At operation 1014, if all octets associated with the RLC SDU corresponding to the SID have been assembled, the RLC reassembly component forwards the reconstructed RLC SDU to an upper layer entity (e.g. a PDCP receiver entity) and stops the reassembly timer associated with the RLC SDU corresponding to the SID.

At operation 1016, the RLC reassembly component determines whether the RLC reassembly timer associated with the RLC SDU corresponding to the SID has expired.

At operation 1018, if all octets associated with the RLC SDU corresponding to the SID have been assembled, or if the RLC reassembly timer associated with the RLC SDU corresponding to the SID has expired, the RLC reassembly component may optionally send a stop indication corresponding to the LCID and SID of this RLC SDU to each of the RLC reception components in the MLG 510.

At operation 1020, if all octets associated with the RLC SDU corresponding to the SID have been assembled, or if the RLC reassembly timer associated with the RLC SDU corresponding to the SID has expired, the RLC reassembly component discards the reassembly map and releases the reassembly buffer corresponding to the LCID and SID of this RLC SDU. The RLC reassembly component will generally stop reassembly operations for the current RLC SDU corresponding to the SID.

At this point, the RLC reassembly component returns to operation 1002 to await the arrival of the next RLC data PDU.

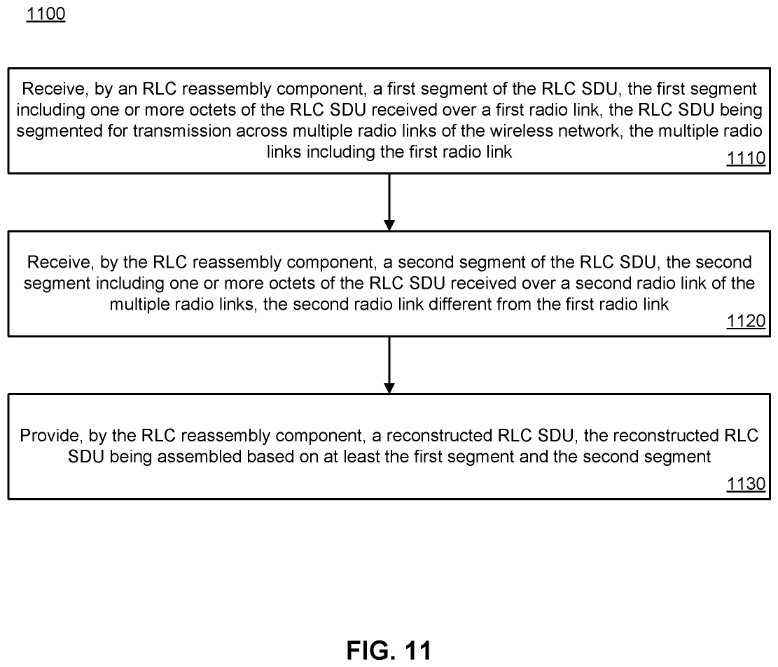

FIG. 11 illustrates, in one embodiment, a method of reconstructing an RLC service data unit (SDU) in a wireless communication network. The method comprises:

At operation 1110, receiving, by an RLC reassembly component, a first segment of an RLC SDU, the first segment including one or more octets of the RLC SDU received over a first radio link, the RLC SDU being segmented for transmission across multiple radio links of a wireless network, the multiple radio links including the first radio link.

At operation 1120, receiving, by the RLC reassembly component 412, a second segment of the RLC SDU, the second segment including one or more octets of the RLC SDU received over a second radio link of the multiple radio links, a number of octets in the second segment being the same or different from a number of octets in the first segment.

At operation 1130, assembling, by the RLC reassembly component, a reconstructed RLC SDU using the first segment and the second segment.

According to various embodiments, a method in a wireless communication network for receiving segments of an RLC SDU may include the following. In a first operation, an RLC reception component associated with a first radio link receives a first segment of the RLC SDU. The first segment may be received by the RLC reception component in response to an automatic repeat request (ARQ) transmitted by the RLC reception component. In a second operation, the RLC reception component forwards the first segment of the RLC SDU to an RLC reassembly component. In a third operation, the RLC reception component discards the first segment of the RLC SDU. In a fourth operation a second RLC reception component associated with a second radio link receives a second segment of the RLC SDU, forwards the second segment of the RLC SDU to the RLC reassembly component, and discards the second segment of the RLC SDU. The second segment may include octets of the RLC SDU that are the same as octets of the first segment or that are different from octets of the first segment.

Potential advantages and benefits provided by the RLC multi-link segmentation and reassembly in the embodiments herein may be as follows. For definiteness, the below potential advantages are not necessarily present in all embodiments of the present invention.
reduces or minimises reassembly delays by using segments received over any radio link to reconstruct an error-free RLC SDU;
mitigates or avoids blockage where a lost RLC segment on one radio link prevents reconstruction of a complete PLC SDU;
reduces forwarding delays for applications requiring low latency;
improves robustness of wireless communications for RLC SDUs that must be segmented for transmission across a radio link;
allows independent segmentation and coding of RLC data PDUs corresponding to signal quality and resource availability on the associated radio link;
allows independent operation of ARQ on each radio link for recovery of lost RLC data PDUs;
facilitates or ensures that ARQ operations are performed by an RLC entity situated close to its associated radio link;
reuses the standard RLC protocol without or with limited change.

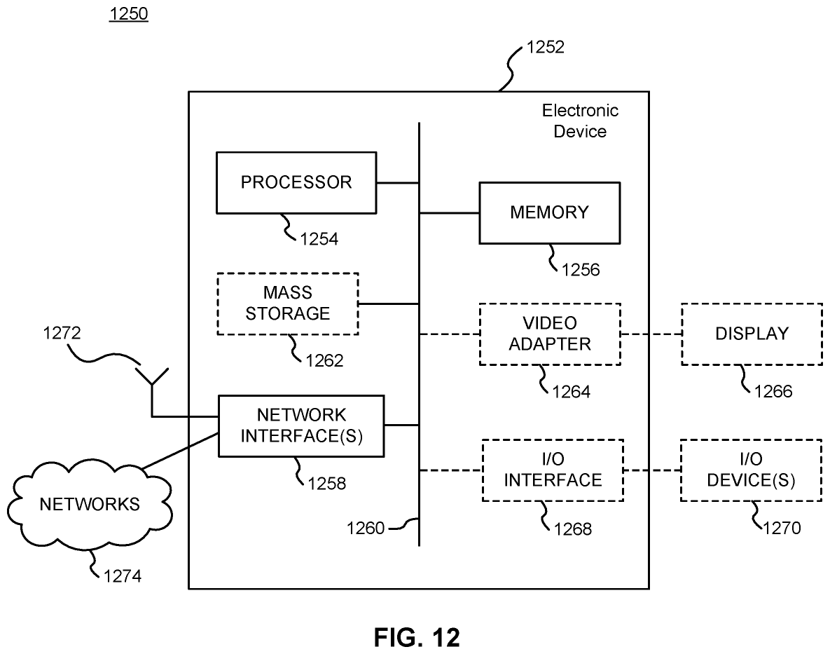

FIG. 12 is a block diagram of an electronic device (ED) 1252 illustrated within a computing and communications environment 1250 that may be used for implementing the devices and methods disclosed herein. In some embodiments, the ED 1252 may be an element (e.g., a physical network element) of communications network infrastructure, such as a RAN node (which may be, for example, a base station, a NodeB, an evolved Node B (eNB), a fifth generation NodeB (sometimes referred to as a gNB or an ng-eNB)), a disaggregated RAN node centralised unit (CU), a disaggregated RAN node distributed unit (DU), a home subscriber server (HSS), a gateway (GW) such as a packet gateway (PGW), a serving gateway (SGW), a user plane gateway (UPGW) or various other nodes or functions within a public land mobile network (PLMN). In other embodiments, the ED 1252 may be device that connects to the network infrastructure over a radio interface, such as a mobile phone, smart phone or other such device that may be classified as a User Equipment (UE). In some embodiments, the ED 1252 may be a machine type communications (MTC) device (also referred to as a machine-to-machine (M2M) device), or another such device that may be categorized as a UE despite not providing a direct service to a user. In some references, an ED 1252 may also be referred to as a mobile device, a term intended to reflect devices that connect to a mobile network, regardless of whether the device itself is designed for, or capable of, mobility. In an embodiment, an ED 1252 may be a wireless device (WD) such as WD 430, a term intended to reflect devices that connect to a network via a radio link. An ED 1252 may utilize all of the components shown or only a subset of the components, and levels of integration may vary from device to device. Furthermore, an ED 1252 may contain multiple instances of a component, such as multiple processors, memories, transmitters, receivers, etc. The ED 1252 typically includes a processor 1254, such as a central processing unit (CPU) and may further include specialized processors such as a graphics processing unit (GPU) or other such processor, a memory 1256, a network interface 1258 and a bus 1260 to connect the components of ED 1252. ED 1252 may optionally also include components such as a mass storage device 1262, a video adapter 1264, and an I/O interface 1268 (shown in dashed outline).

The memory 1256 may comprise any type of non-transitory system memory, readable by the processor 1254, such as static random access memory (SRAM), dynamic random access memory (DRAM), synchronous DRAM (SDRAM), read-only memory (ROM), or a combination thereof. In an embodiment, the memory 1256 may include more than one type of memory, such as ROM for use at boot-up, and DRAM for program and data storage for use while executing programs. The bus 1260 may be one or more of any type of several bus architectures including a memory bus or memory controller, a peripheral bus, or a video bus.

The ED 1252 may also include one or more network interfaces 1258, which may include at least one of a wired network interface and a wireless network interface. As illustrated in FIG. 12, a network interface 1258 may include a wired network interface to connect to a network 1274, and also may include a radio access network interface 1272 for connecting to other devices over a radio link. When ED 1252 is a network infrastructure element, the radio access network interface 1272 may be omitted for nodes or functions acting as elements of the public land mobile network (PLMN) other than those at the radio edge (e.g. a RAN node DU). When ED 1252 is infrastructure at the radio edge of a network 1274, both wired and wireless network interfaces may be included. When ED 1252 is a wirelessly connected device, such as a UE or WD, radio access network interface 1272 may be present and it may be supplemented by other wireless interfaces such as WiFi network interfaces. The network interfaces 1258 allow the ED 1252 to communicate with remote entities such as those connected to network 1274.

The mass storage 1262 may comprise any type of non-transitory storage device configured to store data, programs and other information and to make the data, programs and other information accessible via the bus 1260. The mass storage 1262 may comprise, for example, one or more of a solid state drive, hard disk drive, a magnetic disk drive or an optical disk drive. In some embodiments, mass storage 1262 may be remote to ED 1252 and accessible through use of a network interface such as interface 1258. In the illustrated embodiment, mass storage 1262 is distinct from memory 1256 where it is included and may generally perform storage tasks compatible with higher latency but may generally provide lesser or no volatility. In some embodiments, mass storage 1262 may be integrated with a heterogeneous memory 1256.

The optional video adapter 1264 and the I/O interface 1268 (shown in dashed outline) provide interface to couple the ED 1252 to external input and output devices. Examples of input and output devices include a display 1266 coupled to the video adapter 1264 and an I/O device 1270 such as a touch-screen coupled to the I/O interface 1268. Other devices may be coupled to the ED 1252, and additional or fewer interfaces may be utilized. For example, a serial interface such as a Universal Serial Bus (USB) (not shown) may be used to provide an interface for an external device. Those skilled in the art will appreciate that in embodiments in which ED 1252 is part of a data center, I/O interface 1268 and video adapter 1264 may be virtualized and provided through network interface 1258.

In some embodiments, ED 1252 may be a stand-alone device, while in other embodiments ED 1252 may be resident within a data center. A data center, as will be understood in the art, is a collection of computing resources (typically in the form of services) that can be used as a collective computing and storage resource. Within a data center, a plurality of services can be connected together to provide a computing resource pool upon which virtualized entities can be instantiated.

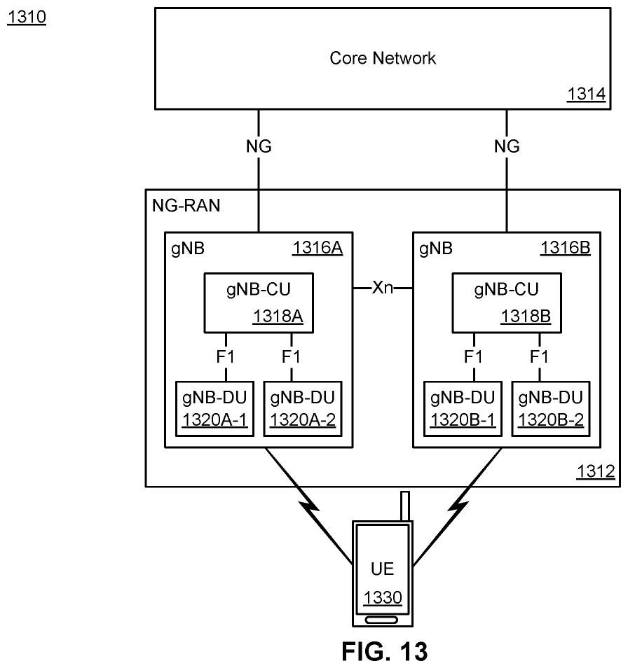

FIG. 13 illustrates an example architecture 1310 for the implementation of a Next Generation Radio Access Network (NG-RAN) 1312, also referred to as a 5G RAN. NG-RAN 1312 is the radio access network that connects a UE 1330 to a core network (CN) 1314. The UE 1330 may, for example, be a WD 430. Those skilled in the art will appreciate that CN 1314 may be the 5GCN. In other embodiments, the CN 1314 may be a 4G Evolved Packet Core (EPC) network. Nodes within NG-RAN 1312 connect to the CN 1314 over an NG interface. This NG interface can comprise both the NG-C interface to a CN control plane function (CPF) and an NG-U interface to a CN user plane function (UPF). NG-RAN 1312 includes a plurality of radio access network (RAN) nodes, including the RPN 410 and RSN 420, that can be referred to as a gNB. In the NG-RAN 1312, gNB 1316A and gNB 1316B are able to communicate with each other over an Xn interface. Within a single gNB 1316A, the functionality of the gNB may be decomposed into a centralized unit (gNB-CU) 1318A and a set of distributed units (gNB-DU 1320A-1 and gNB-DU 1320A-2, collectively referred to as 1320A). gNB-CU 1318A, which may be an RPN 410, is connected to a gNB-DU 1320A, which may be an RSN 420, over an F1 interface. Similarly, gNB 1316B has a gNB-CU 1318B connecting to a set of distributed units gNB-DU 1320B-1 and gNB-DU 1320B-2, collectively referred to as 1320B). Each gNB DU may be responsible for one or more cells providing radio coverage within the PLMN to one or more UEs 1330. In other examples, an NG RAN node may be referred to as an ng-eNB where an ng-eNB-CU is connected to an ng-eNB-DU over a V1 interface. In some embodiments, the gNB-CU and gNB-DUs of a particular gNB can be configured in accordance with embodiments of the present invention, as described above. In some embodiments, the gNB-CU and gNB-DUs of multiple gNBs can be configured in accordance with embodiments of the present invention, as described above. In some embodiments, the RLC reception component of a gNB-DU associated with one gNB may forward RLC data PDU information to the RLC reassembly component of a gNB-CU associated with a different gNB. In other embodiments, an RLC reassembly component may be associated with multiple gNBs. The RLC data PDU information may include one or more segments of an RLC SDU, for example encapsulated in one or more corresponding RLC PDUs. The RLC data PDU information may include information provided by an RLC reception component, as described herein, to an RLC reassembly component, as also described herein.

It should also be understood that any or all of the functions discussed above with respect to the NG-RAN 1312 may be virtualized within, for example, the resource pool of a network data center.

As a further example, a RSN in a wireless network may include a network interface, a radio link interface, a processor, and a non-transitory memory. The non-transitory memory may store instructions that when executed by the processor may cause the RSN to receive, using the radio link interface, a segment of a RLC SDU. The RLC SDU segment may include one or more octets of the RLC SDU and the RLC SDU may be segmented for transmission across the radio link. When the instructions stored in the non-transitory memory are executed by the processor, the RSN may forward, using the network interface, the segment of the RLC SDU and may subsequently discard the segment of the RLC SDU. The segment of the RLC SDU may be received by the RSN in response to an ARQ transmitted using a radio link interface. The RSN may comprise a RAN node DU or a SCG RAN node. The RSN may be configured to forward a segment of the RLC SDU to an RLC reassembly component that may receive RLC SDU information from more than one RSNs. The RSN may also be configured to receive plural segments of the RLC SDU and may forward each RLC SDU segment after successful reception of the RLC SDU segment independent of receiving other RLC SDU segments.

An example of a WD in a wireless network may include a radio link interface, a processor, and a non-transitory memory. The non-transitory memory may store instructions that when executed by the processor may cause the WD to receive, using a radio link interface, a first segment of a RLC SDU. The first RLC SDU segment may include one or more octets of the RLC SDU received over the first radio link. The RLC SDU may be segmented for transmission across multiple radio links of the wireless network. The multiple radio links may include the first radio link. The WD may receive, using the radio link interface, a second segment of the RLC SDU when the processor executes other instructions stored in the non-transitory memory. The second RLC SDU segment may include one or more octets of the RLC SDU received over a second (of multiple) radio links. The processor may also execute instructions stored in the non-transitory memory that may cause the WD to provide a reconstructed RLC SDU. The reconstructed RLC SDU may be assembled based on at least the first RLC SDU segment and the second RLC SDU segment.

An example RAN node in a wireless network may include a first network interface, a second network interface, a processor, and a non-transitory memory. The non-transitory memory may store instructions that when executed by the processor cause the RAN node to receive, using the first network interface, a segment of a RLC SDU. The first segment may include one or more octets of the RLC SDU received over a first radio link. The RLC SDU may be segmented for transmission across multiple radio links of the wireless network. The multiple radio links include the first radio link. Instructions stored in the non-transitory memory that are executed by the processor may cause the RAN node to receive, using the second network interface, a second segment of the RLC SDU. The second segment of the RLC SDU may include one or more octets of the RLC SDU received over a second radio link of the multiple radio links. Instructions stored in the non-transitory memory that are executed by the processor may cause the RAN node to assemble a reconstructed RLC SDU. The reconstructed RLC SDU may be assembled based on at least the first RLC SDU segment and the second RLC SDU segment.

Although various embodiments of the present invention are discussed in terms of increasing transmission reliability, it should be understood that such embodiments can additionally be implemented in order to increase spectral efficiency or decrease latency. This may be achieved by reducing or avoiding unnecessary retransmission of certain PDUs or portions thereof, which have been reliably received via other radio links.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
receiving, by a RLC reassembly component, a first segment of a radio link control (RLC) service data unit (SDU) forwarded by a first RLC reception component associated with a first radio link, the first segment including one or more octets of the RLC SDU;
receiving, by the RLC reassembly component, a second segment of the RLC SDU forwarded by a second RLC reception component associated with a second radio link that is different than the first radio link, the second segment including one or more of the octets of the RLC SDU; and
outputting, by the RLC reassembly component, a reconstructed RLC SDU assembled based on at least the first segment and the second segment, the reconstructed RLC SDU including all octets of RLC SDU.

2. The method of claim 1, further comprising forwarding the reconstructed RLC SDU to another entity in a wireless device or a radio access primary node in the wireless network.

3. The method of claim 1, further comprising:
receiving, by the first RLC reception component, the first segment of the RLC SDU;
forwarding, by the first RLC reception component, the first segment of the RLC SDU to the RLC reassembly component; and
discarding, by the first RLC reception component, the first segment of the RLC SDU.

4. The method of claim 3, wherein the first segment is received by the RLC reception component in response to an automatic repeat request (ARQ) transmitted by the RLC reception component.

5. The method of claim 2, further comprising sending, by the RLC reassembly component, a stop indication to one or both of the first and second RLC reception components when the reconstructed RLC SDU comprises all of the octets of the RLC SDU, the stop indication associated with the RLC SDU.

6. The method of claim 2, further comprising starting, by the RLC reassembly component, a reassembly timer when the first segment of the RLC SDU is received and stopping the reassembly timer when the RLC reassembly component determines that the reconstructed RLC SDU comprises all of the octets of the RLC SDU.

7. The method of claim 2, wherein each of the first segment and the second segment comprise an end segment indication, the method further comprising determining when the reconstructed RLC SDU comprises all of the octets of the RLC SDU based on the end segment indication.

8. The method of claim 1, further comprising starting, by the RLC reassembly component, a reassembly timer when the first segment of the RLC SDU is received and discarding further segments of the RLC SDU received from the first and second RLC reception components when the reassembly timer expires.

9. The method of claim 1, wherein a number of octets in the second segment of the RLC SDU is the same or different from a number of octets in the first segment of the RLC SDU.

10. The method of claim 1, wherein each of the first segment and the second segment comprise an indication of which octets of the RLC SDU are contained therein, the method further comprising reconstructing the RLC SDU based on the indication.

11. A radio access network (RAN) primary node (RPN) in a wireless network, the RPN comprising:
a processor; and
a non-transitory memory storing instructions that when executed by the processor cause the RPN to:
receive a first segment of a radio link control (RLC) service data unit (SDU) forwarded by a first RLC reception component associated with a first radio link, the first segment including one or more octets of the RLC SDU;
receive a second segment of the RLC SDU forwarded by a second RLC reception component associated with a second radio link different than the first radio link, the second segment including one or more of the octets of the RLC SDU; and
output a reconstructed RLC SDU assembled based on at least the first segment and the second segment, the reconstructed RLC SDU including all octets of RLC SDU.

12. The RPN of claim 11, wherein the RPN comprises a RAN node centralised unit (CU).

13. The RPN of claim 11, wherein the RPN comprises a master cell group (MCG) RAN node.

14. The RPN of claim 11, further configured to forward the reconstructed RLC SDU to another entity in the RPN.

15. The RPN of claim 14, wherein each of the first segment and the second segment comprise an end segment indication, the RPN further configured to determine when the reconstructed RLC SDU comprises all of the octets of the RLC SDU based on the end segment indication.

16. The RPN of claim 14, further configured to transmit a stop indication associated with the RLC SDU to one or both of the first and second RLC reception components when the reconstructed RLC SDU comprises all of the octets of the RLC SDU.

17. The RPN of claim 14, further configured to start a reassembly timer when the first segment of the RLC SDU is received and to stop the reassembly timer when the RPN determines that the reconstructed RLC SDU comprises all of the octets of the RLC SDU.

18. The RPN of claim 11, further configured to start a reassembly timer when the first segment of the RLC SDU is received and to discard further segments of the RLC SDU received from the first and second RLC reception components when the RPN determines that the reassembly timer has expired.

19. The RPN of claim 11, wherein each of the first segment and the second segment comprise an indication of which octets of the RLC SDU are contained therein, the RPN further configured to reconstruct the RLC SDU based on the indication.

20. A system comprising:
a first radio link control (RLC) reception component, the first RLC reception component configured to:
wirelessly receive, over a first radio link, a first set of segments of a radio link control (RLC) service data unit (SDU), each segment of the first set of segments including one or more octets of the RLC SDU, the RLC SDU being segmented for transmission across multiple radio links of a wireless network, the multiple radio links including the first radio link; and
forward each segment of the first set of segments of the RLC SDU to an RLC reassembly component;
a second RLC reception component, the second RLC reception component configured to:
wirelessly receive a second set of segments of the RLC SDU, each segment of the second set of segments including one or more octets of the RLC SDU received over a second radio link of the multiple radio links, the second radio link different from the first radio link; and
forward each segment of the second set of segments of the RLC SDU to the RLC reassembly component; and
the RLC reassembly component configured to:
receive the first set of segments of the RLC SDU;
receive the second set of segments of the RLC SDU; and
output a reconstructed RLC SDU assembled based on at least the first set of segments and the second set of segments, the reconstructed RLC SDU including all octets of RLC SDU.
